(19) United States
(12) Patent Application Publication
(10) Pub. No.: US 2004/0258016 A1
(43) Pub. Date: Dec. 23, 2004

(54) Method and device for signalling a codec negotiation over heterogeneous signalling networks

(76) Inventors: Helmut Schmidt, Munchen (DE); Bernd Siegwart, Ettringen (DE); Erik Margraf, Perchtoldsdorf (AT)

Correspondence Address: Siemens Corporation, Intellectual Property Department, 170 Wood Avenue South, Iselin, NJ, 08830, US

(21) Appl. No.: 10/491,974

(22) PCT Filed: Sep. 11, 2002
(86) PCT No.: PCT/DE02/03383

(30) Foreign Application Priority Data
Oct. 5, 2001 (DE) 101 49 284.7

(51) Int. Cl. H04Q 7/00

(52) U.S. Cl. 370/329; 370/431

(57) ABSTRACT

The invention relates to a method and a device for signalling a codec negotiation over heterogeneous signalling networks. In a heterogeneous network environment, interfaces can be present, for a transmission, which are governed by limitations in terms of a codec negotiation. Especially cases in which only a limited set of codecs is supported and/or signalled in the target network, or in which the target network only has a limited number of elements, for example one element, from which proposed codec lists can be extracted or evaluated, present problems. If this is the case, as a result, connections are rejected if non-supported codecs are signalled. The aim of the invention is to provide an improved method for signalling codec negotiations, whereby as few as possible signalling calls are rejected. To this end, a significant idea of the invention is that the list of supported codecs is resorted before the signalling call in the emission network. The codec list is resorted in such a way that a codec which is (highly likely to be) supported by a terminal in the reception network is placed in first position in the list.

### CROSS REFERENCE TO RELATED APPLICATIONS

This application is the U.S. National Stage of International Application No. PCT/DE02/03383, filed Sep. 11, 2002 and claims the benefit thereof. The International Application claims the benefits of German application No. 10149284.7 filed Oct. 5, 2001, both applications are incorporated by reference herein in their entirety.

### FIELD OF INVENTION

The invention relates to a method for the signaling of a codec negotiation via heterogeneous signaling networks according to the preamble of claim 1 and a device for this.

### BACKGROUND OF INVENTION

Communications links for speech transmission have been chiefly connection-oriented until now. For signal transmission between two communication end points only one physical link is provided which is reserved for the entire period of the link. This is also described as line-oriented transmission, static routing or circuit switching.

With the emergence of packet-oriented data networks (packet switching), such as, for example, the Internet, reduced cost communications or improved opportunities for integration of value-added services are offered in the fixed network range compared with connection-oriented telecommunications. In particular, this is due to efficient utilization of the capacity of a link as, unlike circuit switching, packet switching does not occupy the physical transmission medium for the entire duration of the link. Sophisticated business solutions for speech transmission via packet-based protocols, for example Frame Relay, have been available on the market for some time. Therefore, the idea of packing speech into IP packets as well was not so very alien. VOIP (Voice over IP) solutions are of particular interest to companies that have an IP router network and use the public telephone network.

All VOIP solutions operate largely according to the same system. The data for transportation is divided into individual data packets, with each data packet receiving an address code which designates the recipient of the transmission. The individual data packets are then transmitted independently of each other—they may even use different transmission paths for this. The principle of packet switching is defined in various standards; a known standard is disclosed in ITU-T Recommendation x.25.

It is predicted that VOIP will play a significant role in future speech communications. For this, speech is digitized and where appropriate, compressed by hardware or software (source-coded), where the compressed speech then represents the useful data range of the IP packets. Selected call numbers are converted into IP addresses which are included as target information in the IP header. The IP packets are now transported to the distant terminal of the speech link via several network nodes distributed in the data network. The distant terminal stores the incoming packets and assembles them in the correct sequence again. If a packet is damaged or lost, it is not resent. At the distant terminal, the speech information is removed from the packets and then supplied to a coding device in which the information is then reverse source-coded and/or channel-coded and finally made audible via appropriate hardware.

Hardware and software modules which combine the functions of a coder and a decoder are designated as codecs, as during the transmission of information between two points transmission often takes place in both directions. Sometimes the codec is especially tailored to the characteristics of an input signal, for example, speech and/or video signals. Practical implementation is either as hardware by means of DSPs (Digital Signal Processors) or by means of codec programs implemented in software.

In order to minimize the requisite storage space of a complex data stream, for example, audio and/or video data, the data is compressed according to defined algorithms. A data expansion algorithm that reverses compression is required for the use of the data. This means that every compression entails corresponding decompression which precisely inverts this compression. The hardware and software solutions created for this are usually also designated as codecs. A data stream coded or compressed with a particular codec may only be decoded or decompressed using this codec.

Known codecs are, for example, G.711, G.722, G.723, G.726, G.728, G.729 or GSM codecs for the mobile radio communications sphere. G.711 is a recommendation from the International Telecommunications Union (ITU) which describes the digitization of audio data in telephone quality (3.1 kHz bandwidth) with a throughput of 56 kbit/s or 64 kbit/s. The method is described as pulse code modulation and is used in the analog telephone network or in ISDN. G.723 defines a speech compression method for use in narrowband, multimedia applications with throughputs of 6.4 and 5.3 kbit/s. The method was originally developed by the ITU with a view to use in narrowband videoconference systems and is now used increasingly in IP telephony. Additional codecs are, for example, MP3 (MPEG layer III audio) for highquality music data on the Internet, H.261 or H.263 for video conferences of low or medium quality or Sorenson video for high-quality www-video data.

Data for reducing storage space requirements or for accelerating the sending of data is coded with these codecs. On the receiver side, as already mentioned, the codec used when sending data must be available for decoding/decompression of the received data. In order to be able to ensure working data transmission from this point of view, a codec list is generated by the transmitting terminal and an agreement reached regarding the codec to be used when sending and receiving by means of a so-called negotiation. The codec negotiation executes in conjunction with call signaling. In the codec negotiation, the received terminal selects a codec supported by it from the received codec list. This choice is signaled back to the transmitting terminal.

In a heterogeneous network environment, during a transmission there may be interfaces which are subject to restrictions with regard to codec negotiation. In particular, problems arise as a result of cases in which only a restricted set of codecs is supported and/or signaled in the target network or in which only a limited number of elements, for example, one element, can be extracted or evaluated from the proposed codec list in the target network. If applicable, links are then rejected as a consequence if unsupported codecs are signaled.

### SUMMARY OF INVENTION

The object of the present invention is consequently to indicate an improved method for the signaling of codec negotiations in which as few signaling calls as possible are rejected.

This object is achieved by a method to which claim 1 relates. An essential idea of the invention is that before the signaling call in the transmission network, the codec list of supported codecs is rearranged. Rearrangement of the codec list takes place in such a way that a codec that is (in all probability) supported by a terminal in the receiving network is placed first on the list. The list is arranged according to a defined and administratively predetermined sequence. It then makes sense that a codec is first in the defined sequence that is supported by terminals in as many networks as possible. This results in the rejection of the call by the terminal in the receiving network in a significantly lower number of signaling calls and thus increases the success rate of transmissions. In the aforesaid and hereafter, the term terminal is understood to mean a terminal or a switching center. The essential point is that a corresponding call signaling protocol is terminated there.

The application of the method for transmission in accordance with the present invention is advantageous, for example, for tariff reasons, where a transit network is interposed between transmission network and receiving network. This makes sense e.g. in an application of the method in IP telephony. For example, two terminals can be in the public telephone network which serves both as a transmitting and receiving network. An IP network, for example, the public Internet, is used as a transit network. By this means, for example, a telephone conversation between Munich and Hamburg is made possible at lower prices than a comparable toll call made completely via the public telephone network.

Preferably, a terminal in the transit network signals the codec list unchanged to a terminal in the receiving network. Likewise, preferably, the terminal in the transit network selects a limited number of elements, in particular only the first element, from the codec list. Even if the terminal in the transit network only supports the first element in the codec list, nevertheless all the information, in particular, the complete codec list of the transmitting network is thus forwarded to the receiving network. The codec negotiation between the terminal in the receiving network and the terminal in the transmitting network is therefore not subject to restrictions of any kind as a result of possibly restricted support for the codec list of the terminal in the transit network.

A device in accordance with the present invention has a transmitting network with terminal (terminal in the narrower sense or an interworking point (IWP)) which supports at least one codec, and a receiving network with a terminal which likewise supports at least one codec. Furthermore, the device has a sorting device for sorting the codec list.

An advantageous embodiment of the arrangement according to the invention has a sorting device comprising a database for storage of a defined sequence of codecs in the codec list. Furthermore, the sorting device has a processor for sorting the codec list.

In a preferred arrangement of the invention, the terminal in the transmitting network corresponds to the H.323 standard. The H.323 standard is a recommendation of the International Telecommunications Union (ITU) and discloses the transport of multimedia data via IP-based networks, in particular, transport in bi-directional, real-time communication links.

### BRIEF DESCRIPTION OF THE DRAWING

Further advantageous embodiments arise from subclaims and the following description of preferred exemplary embodiments which are explained in more detail on the basis of the diagrams. These show:

FIG. 1 a set-up of a communications terminal according to the H.323 standard,

FIG. 2 a simplified diagram of a network environment with two networks,

FIG. 3 a simplified diagram of a network environment with two networks for a method of the present invention and

FIG. 4 a simplified diagram of a network environment with three networks for a method according to the present invention.

### DETAILED DESCRIPTION OF INVENTION

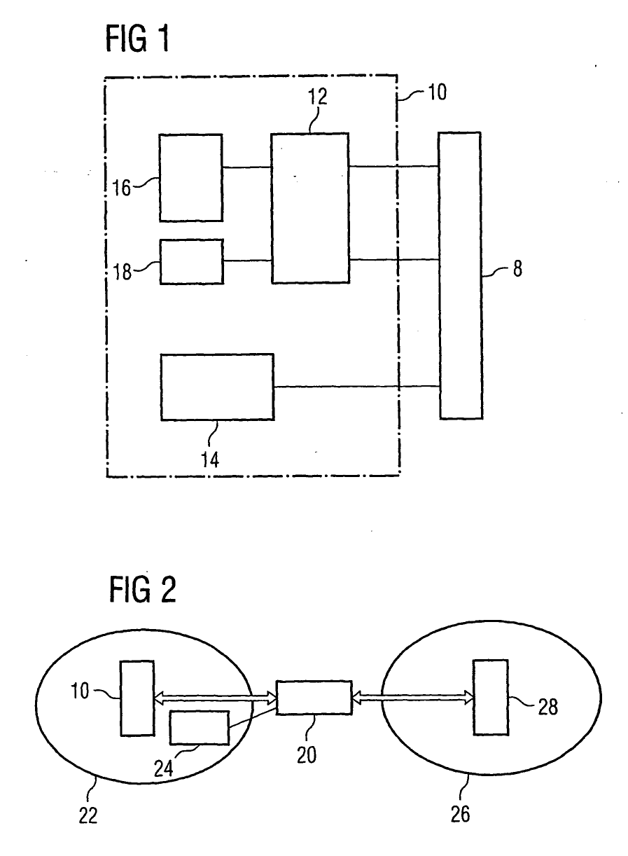

FIG. 1 provides a diagrammatic view of a system set-up of a terminal 10 according to the H. 323 standard which is a recommendation of the International Telecommunications Union (ITU) and was developed for video conferences via LANs (Local Area Networks) and WANs (Wide Area Networks). The H.323 standard takes into account characteristics of data transmission in LANs and other packet switching networks, for example fluctuating throughputs and delays. Overall, H.322 is generally intended for application via networks which do not provide guaranteed QoS (Quality of Service) for the duration of the link.

H.323 uses the protocols UDP (User Datagram Protocol) and RTP (Real-Time Protocol) known from the Internet. A protocol device 12 defines the coding of audio signals and video signals. For each data category, audio/video data, data packets or control signals, there are individual codecs which are likewise standardized. Which codec is used in a communication depends on the resources available (computer power, transmission bandwidth) and the quality desired and is determined by the control system 14 when setting up the link. The control system 14 uses standardized codecs for this, for example, G.711, G.722, G.723 and MPEG-1 as audio codecs, and H.261 and H.263 as video codecs. However, coding of the data with codecs and code signaling are not linked to the IP as a transport layer. Other transport layers, for example, ATM, may also be used.

In the audio codec 16, in particular, the G.723 standard for VOIP transmission is assigned an important role, as at the end of coding according to this standard, data flow with a transmission rate of 5.3 kbit/s with good speech quality is available. To transmit moving-image material via VoIP networks, the video data is compressed by means of the video codec 18. Here, in particular, the H.263 standard plays an important role as it compresses codec video data to a transmission rate of less than 64 kbit/s.

Connection management in a control system 14 is based on signaling protocols, for example H.245 and the protocol H.225 based on Q.931. The terminal 10 is linked via a LAN interface 8, for example with a gateway. Several H.323 systems may be linked to each other via a LAN network. Terminals in this network can communicate with terminals in other networks via a gateway.

FIG. 2 shows a heterogeneous network environment for a signaling method in which two networks 22, 26 are linked via a gateway 20. The first network 22 is shown with a terminal 10 according to FIG. 1 and a gatekeeper 24. The second network 26 has a terminal 28 according to an ISUP+ standard. An ISUP+ standard does not really denote a standard. ISUP+ in a proprietary expansion of the ISUP standard in the migration to BICC.

The transition from the first network 22 to the second network 26 and the associated conversion between various transmission formats takes place via the gateway 20. Gateways are used, for example, to connect the public telephone network to the Internet. The gatekeeper 24 has the task of inspecting the access authorization of the user when setting up a link, of carrying out address conversions and of managing the bandwidth available for communication. The second network can also have a gatekeeper without restricting the general public, even if it is not shown in this example.

In a signaling call, the terminal 10 signals a codec list to the terminal 28 via the gateway 20, for example with the codec G. 723 at the top of the list. For this standard a data flow of only 5.3 kbit/s is sufficient. However, as the terminal 28 does not have this codec G.723 at its disposal, the call set-up between terminal 10 and terminal 28 is disconnected by this. Terminal 28 rejects the signal call of terminal 10.

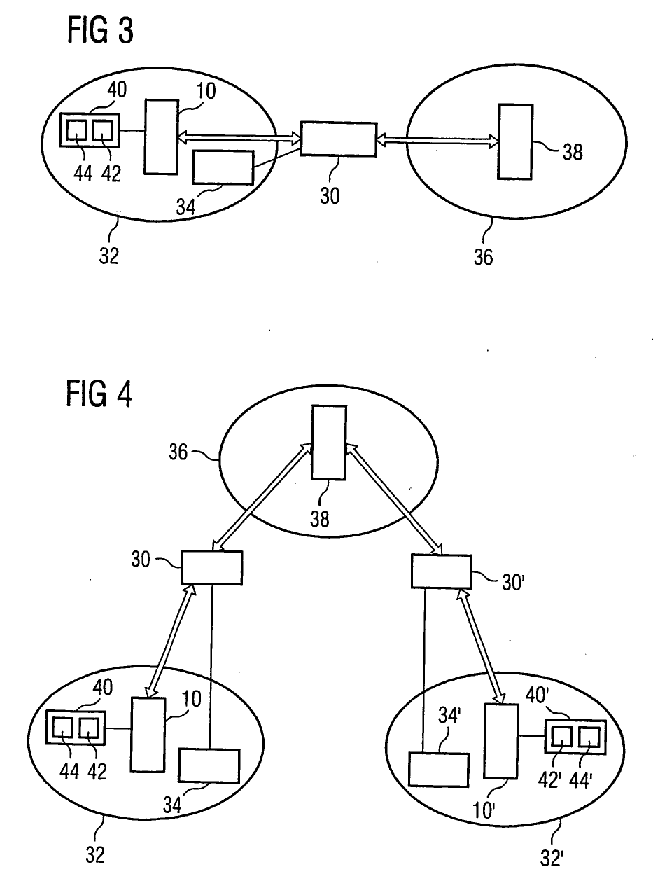

FIG. 3 shows an arrangement of a heterogeneous network environment of two networks 32, 36, which are linked via the gateway 30, in which the method according to the invention becomes effective. The networks 32, 36 each have a terminal or an exchange 10, 38 with respective codecs which are compiled in a codec list. Terminal 10 is a terminal according to the H.323 standard, while terminal 38 is configured according to the ISUP+ standard. With the aforementioned components of FIG. 3, this arrangement corresponds approximately to the arrangement from FIG. 2. The set-up and the function of the gatekeeper 34 also correspond to the set-up and the function of the gatekeeper 24 and are not described again here.

In contrast to the arrangement from FIG. 2, the network 32 also has a sorting device 40. The sorting device 40 manages the codec lists of all the codecs supported by terminal 10. To this end, the sorting device 40 has a database 42 for storing the codec list. In addition, the sorting device 40 has a resorting level 44 for generating the codec list which terminal 10 signals to terminal 38 via the gateway 30. The sorting device 40 must not be assigned to the network 32. It may also, for example, be assigned to the gateway 30 or generally to an IWP between to networks.

The primary list of codecs supported by terminal 10 is resorted in the sorting device 40 in relation to the sequence stored in the database 42. For example, this list may be resorted in such a way that the codec G.723 is no longer first on the list, but instead the codec G.711. The terminal 10 now signals this resorted list to terminal 38 via the gateway 30. As terminal 38 also supports the standard G.711, the signaling call of terminal 10 is not rejected by terminal 38, a link between the two terminals 10, 38 therefore comes about.

FIG. 4 shows a network arrangement which comprises the elements of the arrangement from FIG. 3 and additionally a network 32′. The embodiment of the networks 32, 36 from FIG. 4 corresponds to that of the networks 32, 36 from FIG. 3 and is not described again at this point. The additional network 32′ comprises a gatekeeper 34′, a terminal 10′ according to the H.323 standard and a sorting device 40′. The sorting device 40′ also has a database 42′ for storing the codec list and a resorting level 44′ for sorting the codec list.

Terminal 10 signals a call set-up to terminal 10′. However, this does not take place via a direct connection between these but via the gateway 30, the network 36 and the gateway 30′. In FIG. 4 the networks 32 and 32′ are represented as two networks of the same kind. However, it is also possible that the network 32′ is identical to the network 32, or also that the two networks 32 and 32′ are different. For example, “networks” 32, 32′ could be different exchange areas of the public telephone network and the network 36 the Internet.

In the constellation shown in FIG. 4, the network 36 is used as a transit network. However, terminal 38 does not support all codecs which support the terminals 10, 10′. In a resorted signaling call from terminal 10, terminal 38 would reject the call if a codec which is not supported by terminal 38 is first on the codec list sent. Forwarding of the signaling call from terminal 10 to terminal 10′ would not come about as a result. The sorting unit 40 therefore resorts the codec list of codecs supported by terminal 10 in such a way that a codec which also supports terminal 38 is first on the list. Terminal 38 therefore does not reject the signaling call but for its part calls terminal 10′.

Terminal 10 is then connected to terminal 10′ via terminal 38. The codec list resorted by the sorting device 40 is signaled onwards in full to terminal 10′ by terminal 38. In this way, terminal 10′ receives a codec list with all the codecs supported by terminal 10, even if some of these codecs in this list are not supported by terminal 38. The codec list of terminal 38, which is restricted in comparison with the codec lists of terminals 10, 10′, has absolutely no restricting influence on the signaling of the codec list from terminal 10 via the gateway 30, the terminal 38 and the gateway 30′ to the terminal 10′.

Network environments were shown in FIGS. 3 and 4, in which the respective transmitting network 32 has a sorting device 40 for sorting the codec list. The network 36 does not have a corresponding sorting device in either of the two diagrams. However, it is apparent that in practice the network shown here to illustrate the invention solely as a receiving or transit network can also have such a sorting device. It is likewise clear that it is not imperative for the network 32′ in FIG. 4 to have the sorting device 40′ in the aforementioned situation for the application of the method in accordance with the present invention.

The implementation of the invention is not restricted to the examples described and aspects highlighted above, but is also possible within the framework of the claims likewise in numerous modifications within the framework of professional action.

1.-9. (canceled).

10. A method for signaling between switching nodes or terminals in networks where the terminals in each network support at least one codec, comprising:
establishing a connection between a transmitting terminal in the transmitting network and a receiving terminal in a receiving network via an interface;
signaling of a codec list by the transmitting terminal to the receiving terminal containing all the codecs supported by the transmitting terminal,
sorting of the codec list of codecs supported by the transmitting terminal in such a way that the list has a defined sequence of codecs; and
negotiating of the terminals of the transmitting network and the receiving network according to the sorted codec list.

11. A method according to claim 10, wherein the establishing of a connection comprises:
establishing a connection between the transmitting terminal in the transmitting network with a terminal in a transit network via an initial interface; and
establishing a connection between the terminal in the transit network and the receiving terminal in the receiving network via an additional interface.

12. A method according to claim 11, wherein the transmitting network and the receiving network are identical.

13. A method according to claim 11, wherein the terminal in the transit network signals the codec list onwards unchanged to the receiving terminal in the receiving network.

14. A method according to claim 10, wherein the terminal in the transit network evaluates a limited number of elements, in particular only the first element, in the codec list.

15. An arrangement for conducting a method for signaling between switching nodes or terminals in networks where the terminals in each network support at least one codec, the method comprising:
establishing a connection between a transmitting terminal in the transmitting network and a receiving terminal in a receiving network via an interface;
signaling of a codec list by the transmitting terminal to the receiving terminal containing all the codecs supported by the transmitting terminal,
sorting of the codec list of codecs supported by the transmitting terminal in such a way that the list has a defined sequence of codecs; and
negotiating of the terminals of the transmitting network and the receiving network according to the sorted codec list, wherein the arrangement comprises:
a transmission network with a transmitting terminal which supports a plurality of codecs and generates and sends a codec list of the codecs supported;
a receiving network having a receiving terminal (10′, 38), which supports at least one codec, and having an interface via which the transmitting and receiving network (32, 32′, 36) are linked together and via which the codec list is transmitted, wherein
a sorting device is provided in the transmitting network to sort the codec list.

16. An arrangement according to claim 15, wherein the sorting device comprises a database for storage of a defined sequence of codecs in the codec list, and a resorting level for resorting the codec list according to a codec priorization in the receiving network.

17. An arrangement according to claim 15, wherein the sorting device is assigned to the transmitting terminal.

18. An arrangement according to claim 15, wherein the sorting device is assigned to a gateway controller of the interface.

19. A method according to claim 12, wherein the terminal in the transit network signals the codec list onwards unchanged to the receiving terminal in the receiving network.

20. A method according to claim 11, wherein the terminal in the transit network evaluates a limited number of elements, in particular only the first element, in the codec list.

21. A method according to claim 12, wherein the terminal in the transit network evaluates a limited number of elements, in particular only the first element, in the codec list.

22. A method according to claim 13, wherein the terminal in the transit network evaluates a limited number of elements, in particular only the first element, in the codec list.

23. An arrangement according to claim 16, wherein the sorting device is assigned to the transmitting terminal.

24. An arrangement according to claim 16, wherein the sorting device is assigned to a gateway controller of the interface.
